(19) United States
(12) Patent Application Publication
(10) Pub. No.: US 2025/0379318 A1
(43) Pub. Date: Dec. 11, 2025

(54) SCALABLE POWER ELECTRONICS MODULE FOR A BATTERY SYSTEM

(71) Applicant: Caterpillar Inc., Peoria, IL (US)

(72) Inventors: Timothy BEETLER, Peoria, IL (US); Brian R. BELL, West Lafayette, IN (US); C. Brahm LANDIS, Indianapolis, IN (US); Jose MIRANDA, Peoria, IL (US)

(73) Assignee: Caterpillar Inc., Peoria, IL (US)

(21) Appl. No.: 18/736,848

(22) Filed: Jun. 7, 2024

(51) Int. Cl. H01M 50/271; H01M 50/204; H01M 50/507; H01M 50/51; H01M 50/583; H01M 50/591

(52) U.S. Cl. CPC H01M 50/271; H01M 50/204; H01M 50/507; H01M 50/51; H01M 50/583; H01M 50/591; H01M 2200/103

(57) ABSTRACT

A service housing for a battery module may include an enclosure coupled to an end of the battery module, and a cover assembly coupled to a service end of the enclosure. The cover assembly may include a first removable cover removably attachable over a first service area portion of the service end, a second removable cover removably attachable to the service end and including an opening allowing access to a second service area, a third removable cover removably positioned within the opening of the second removable cover, and a fourth removable cover removably attachable to the second removable cover opposite the enclosure so as to cover the opening.

### TECHNICAL FIELD

The present disclosure relates generally to battery modules, and more particularly, to a service housing for a battery module.

### BACKGROUND

With the advancement of battery technology has come an increased demand for battery powered equipment, such as battery powered electric vehicles. The increasing demand for battery powered equipment has resulted in an increased development rate for battery technology, as well as increasing variations in the number and type of batteries used. Battery packs also require servicing, often within the interior of service housings connected to the battery modules or packs, which can be dangerous to the technician. Furthermore, as battery technology improves, battery powered equipment and the associated battery packs are being used in increasingly inhospitable environments, subjecting the battery packs and their service housings to dust, water, and variations in altitude.

U.S. Patent Application Publication No. 11,077,921, published on Aug. 3, 2021 (“the '921 publication”), describes a pressure tolerant energy system that may comprise a pressure tolerant cavity and an energy system enclosed in the pressure tolerant cavity configured to provide electrical power to a vehicle. In some embodiments, the battery system may comprise a seamless, welded, corrosion resistant stainless steel box which encloses a battery cell assembly. The enclosure may have a removable lid with a form factor that houses the battery management electronics and may provide pass-through (penetration) ports for power, serial data communication, and/or oil-filling. The lid may be large enough to provide for internal cable routing from the cell stack to the battery management circuitry and on through the power & data penetrator. However, the '921 publication does not describe combinable service housings with separately accessible service areas and multiple access points.

The modules of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a service housing for a battery module, the service housing including an enclosure coupled to an end of the battery module, and a cover assembly coupled to a service end of the enclosure. The cover assembly may include a first removable cover removably attachable over a first service area portion of the service end, a second removable cover removably attachable to the service end and including an opening allowing access to a second service area, a third removable cover removably positioned within the opening of the second removable cover, and a fourth removable cover removably attachable to the second removable cover opposite the enclosure so as to cover the opening.

In another aspect, the disclosure relates to a battery pack, the battery pack including a plurality of battery modules, each module having a service housing connected to a longitudinal end of the battery module. The service housing may include including an enclosure coupled to an end of the battery module, a cover assembly coupled to a service end of the enclosure. The cover assembly may include a first removable cover removably attachable over a first service area portion of the service end, a second removable cover removably attachable to the service end and including an opening allowing access to a second service area, a third removable cover removably positioned within the opening of the second removable cover, and a fourth removable cover removably attachable to the second removable cover opposite the enclosure so as to cover the opening. The service housings of each module may be combined so as to form a service housing assembly.

In yet another aspect, the disclosure relates to a method of assembling a battery pack, the method including coupling a plurality of battery modules to form a battery pack, wherein each battery module includes a service housing including an enclosure coupled to an end of the battery module, and a cover assembly coupled to a service end of the enclosure. The cover assembly may include a first removable cover removably attachable over a first service area portion of the service end, a second removable cover removably attachable to the service end and including an opening allowing access to a second service area, a third removable cover removably positioned within the opening of the second removable cover, and a fourth removable cover removably attachable to the second removable cover opposite the enclosure so as to cover the opening.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of a battery pack, according to aspects of the disclosure.

FIG. 2 is an exploded view of the housing assembly of FIG. 1.

FIG. 3 is a top view of the interior of the housing assembly of the battery pack of FIG. 1.

FIG. 4 provides a flowchart depicting an exemplary method for assembling the battery pack of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

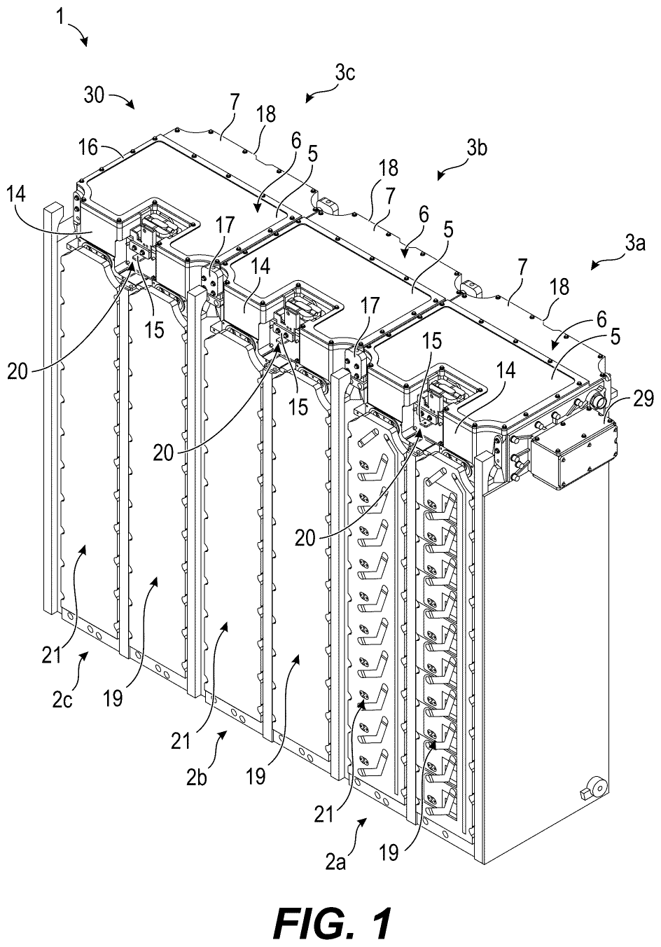

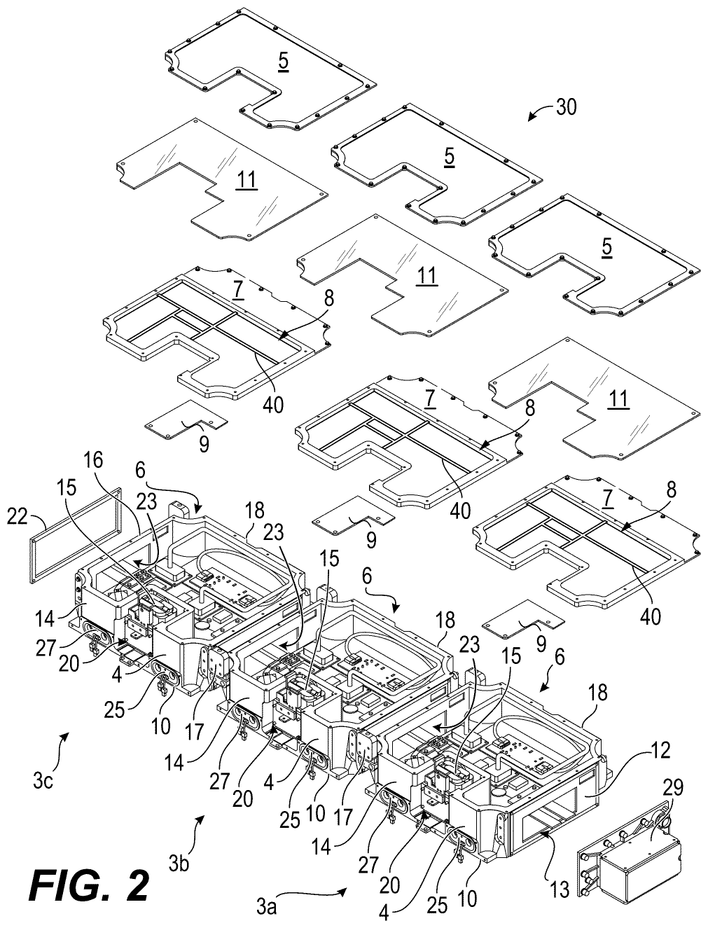

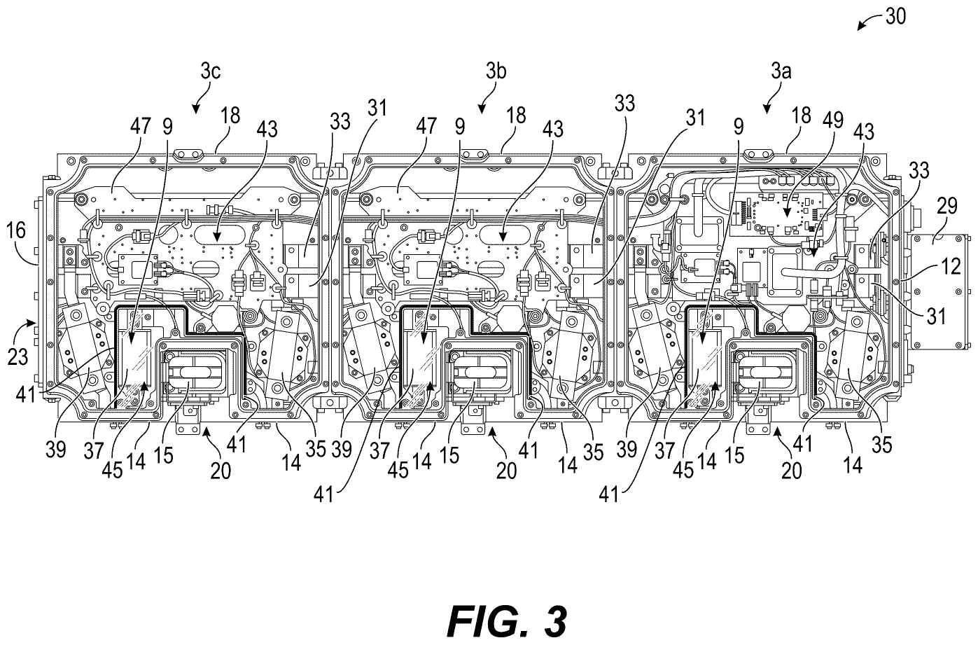

FIG. 1 is a front perspective view of a battery pack 1 and battery modules 2a, 2b, 2c, according to an example embodiment. Each battery module includes a service housing 3a, 3b, 3c located at a longitudinal end or top of each battery module 2a-2c. FIG. 2 and FIG. 3 are an exploded view and a top view of the service housings 3a-3c of the battery modules 2a-2c of FIG. 1, respectively. As will be explained in more detail below, the battery pack 1 may be made of multiple combinable modules 2a-2c, that electrically connect to one another to form the battery pack 1. Each service housing 3a-3c may have a number of service areas and a number of protective removable covers that allows for access to various components of the modules 2a-2c while providing added protection for technicians servicing the battery pack 1. Moreover, the combinable modules 2a-2c are combined and sealed by service housing 3a-3c such that the internal components are protected from dust and water, and are also able to function at a variety of altitudes. The service housings 3a-3c, also known as power electronics modules, may contain power electronics for monitoring and controlling the battery modules 2a-2c and the battery pack 1. The power electronics modules, may be scalable, such that a number of power electronics modules may be combined to monitor and control the modules 2a-2c within a battery pack 1.

Referring to FIGS. 1-3, the battery pack 1 may include a row of battery modules 2a-2c coupled together, each having a first string of battery cells, right battery cell string 19, and a second string of battery cells, left battery cell string 21 in series. Each module 2a-2c may further include a respective service housing 3a-3c connected to a longitudinal end of the battery modules 2a-2c. The service housings 3a-3c of each respective battery module 2a-2c may be combined so as to form a single service housing assembly, housing assembly 30, capable of controlling battery pack 1, and the battery modules 2a-2c therein.

Each service housing 3a-3c may include an enclosure 4 coupled to an end of the modules 2a-2c. Within each enclosure 4 may be a first service area, fuse service area 45, and a second service area, contactor service area 43, separated by a safety barrier 41. Each service housing 3a-3c may further include a cover assembly having a number of different removable covers removably attached to the service end, top end 6, of each enclosure 4. The cover assembly may include a first removable cover, fuse cover 9, that may be removably attached to an enclosure 4 so as to be positioned atop the safety barrier 41 and over the fuse service area 45. The cover assembly may further include a second removable cover, top plate 7, that may be removably attached to the top end 6 of an enclosure 4, above the fuse cover 9. Within each top plate 7 may be an opening, service opening 8, above the fuse service area 45 and the contactor service area 43 that allows access to the contactor service area 43. Each service opening 8 may further include a support structure 40. The cover assembly may further include a third removable cover, contactor cover 11, that may be positioned within the thickness of the service opening 8 of the top plate 7, above the support structure 40. The cover assembly may further include a fourth removable cover, service cover 5, that may be removably attached to the surface of each top plate 7 opposite the enclosure 4, so as to cover the service opening 8, and enclose the contactor cover 11 within the service opening 8.

In the embodiments shown in FIGS. 1-3, the battery pack 1 includes three battery modules 2a-2c, with respective service housings 3a-3c. In other embodiments, the battery pack 1 may have four or more battery modules and respective service housings. In other embodiments, the battery pack I may have one or two battery modules and respective service housings.

Referring again to FIGS. 1-3, the enclosure 4 of each service housing 3a-3c may include a base 10 opposite the top end 6, and vertical sides, including right side 12, front side 14, left side 16, and back side 18, extending generally perpendicularly away from the base 10 towards the top end 6 of the enclosure 4. The right side 12 of each service housing 3a-3c may have a first side opening, right opening 13, and the left side 16 of each service housing 3a-3c may have a second side opening, left opening 23. The front side 14 of each of the service housings 3a-3c may form a “U” shaped recess 20 extending towards the back side 18. The front side 14 of each of the service housings 3a-3c may also include a first battery port, right battery port 25, between the recess 20 and the right side 12, and a second battery port, left battery port 27, between the recess 20 the left side 16.

The enclosures 4 of each of the service housings 3a-3c may be monolithic, such that entirety of each enclosure 4 may be machined from a single piece of material, such as aluminum. In other embodiments, the enclosure 4 may be made from another suitable material, and may be formed by another suitable means. In some embodiments the enclosure 4 may be made from multiple pieces and multiple types of materials.

The top plate 7 may be attached to the enclosure 4 of each of the service housings 3a-3c such that a face of top plate 7 nearest the base 10 abuts the top end 6 of the enclosures 4. The top plates 7 may be shaped to match the general profile of the top end 6 of the enclosures 4. The service opening 8 of each top plate 7 extends between the faces of the top plate 7, and spans the top plate 7 such that only a section of the top plate 7 near the back side 18 of the enclosure 4 covers the interior of the enclosure 4. In other words, the service opening 8 spans the sections of the top plate 7 that would otherwise cover the contactor service area 43 and the fuse service area 45, such that contactor service area 43 and the fuse service area 45 are accessible through the service opening 8.

Within each service opening 8 may be support a support structure 40 that that provides support and/or attachments points for the contactor cover 11. The support structure 40 may also be used to secure the fuse cover 9 in position below the support structure 40.

The fuse cover 9 may be placed between the fuse service area 45 and the top plate 7, so as to provide a barrier between the service opening 8 and the fuse service area 45. In some embodiments, the fuse covers 9 may be attached to an internal support within the enclosures 4, or they may be connected to the enclosures 4 in another suitable fashion.

A contactor cover 11 may be positioned within the thickness of the service opening 8 and atop the support structure 40. The contactor cover 11 may be attached to the support structure 40 or may be attached to attachment points within the enclosure 4 of each of the service housings 3a-c. The contactor cover 11 may be shaped such that it spans the area within service opening 8 less the area directly above the fuse cover 9. In this manner, the contactor cover 11 covers the fuse service are 43, and provides a barrier between the service openings 8 and the contactor service areas 43. Together, the fuse cover 9 and the contactor cover 11 may overlie the area within an enclosure 3a-3c that would otherwise be exposed by service opening 8 within the top plate 7.

The service cover 5 may be removably attached to the face of each top plate 7 opposite the enclosures 4 so as to be over the fuse cover 9 and the contactor cover 11. The service cover 5 may cover the entire service openings 8 and enclose the contactor cover 11 within the service opening 8. When the service cover 5 is attached to the top plate 7, the two may cover the entire area between the sides 12, 14, 16, and 18 of the service housings 3a-3c.

Seals (not shown) may be placed between the top ends 6 of the enclosures 4 and the top plates 7. In some embodiments, at least of a portion of the seals may be inlaid within either or both of the top ends 6 of the enclosures 4 and the top plates 7. Seals may also be placed between the top plates 7 and the service covers 5, and may at least partially be inlaid within either or both of the service covers 5 or the top plates 7.

Connectors 17 may be used to connect the left side 16 of one of the service housings 3a-3c to the right side of another of the service housings 3a-3c. The connectors 17 may span between, and attach to, the front side 14 of each of the adjoining service housings 3a-3c, and may also span between, and attach to, the back sides 18 of each of the adjoining service housings 3a-3c, so as to press two of the adjoining service housings 3a-3c against each other. For example, connectors 17 may be used to connect the left side 16 of service housing 3a to the right side of the service housing 3b, so as to cause the service housings 3a and 3b to press against one another. The connectors 17 may be attached to the service housings 3a-3c using screw, bolts, or any other suitable attachment means.

Between adjoining service housings 3a-3c, for example, between service housings 3a and 3b, the left opening 23 of the service housing 3a and the right opening 13 of service housing 3b may form a passage between the service housings 3a and 3b. Seals (not shown) may be placed between the left side 16 and the right side 12 of adjoining service housings 3, and may be at least partially embedded within either or both of the left side 16 and the right side 12.

The service housing 3a may have a doghouse 29 attached to the right opening 13. In other embodiments, the doghouse 29 may be attached to the left opening 23. The doghouse 29 may comprise various interfaces and openings for connections of electrical equipment to the service housings 3a-3c. The doghouse 29 may also have a breather to allow the interior of the service housings 3a-3c to change its internal pressure of the service housings 3a-3c as necessary when sealed. The service housing 3c may have an end plate 22 that covers its left opening 23 when not connected to another service housing 3a-3b on that side, or a doghouse 29. The end plate 22, doghouse 29, top cover 7, and service cover 5 may form dust, air, and water tight seals with their respective service housings 3a-3c, such that the housing assembly 30 is dust, air, and water tight when the service housings 3a-3c are combined. In some embodiments, the housing assembly 30 may be sealed so as to meet ingress protection codes, such as IP 66 and/or IP 67.

An electrical disconnect 15 may be placed within each of the recesses 20, external to the enclosures 4. Each electrical disconnect 15 may have a first, or right terminal and a second, or left terminal, that electrically connect the portion of the fuse service area 45 between the recess 20 and the right side 12 of each service housing 3a-3c with the portion of the fuse service area between the recess and the left side 16 of each service housing 3a-3c. The disconnect 15 may have a closed position, wherein the terminals of the disconnect 15 are electrically connected, and an open position, wherein the terminals of the disconnect 15 are electrically disconnected. Thus, when the disconnect 15 is in the closed position, the portions of the fuse service area 45 on either side of the recess may be electrically connected.

As best seen within FIG. 3, within each of the service housings 3a-3c, the fuse service area 45 may be located near the front side 14, and may generally surround the recess 20. The safety barrier 41 may generally surround the portion of the fuse service area 45 not bordered by the front side 14 of the enclosure 4. The ends of the safety barrier 41 may terminate at front side 14 of the enclosure 4 on either side of the recess 20. The contactor service area 43 may extend from the portions of the front side 14 of the enclosure 4 not inscribed by the safety barrier 41 towards the back side 18 of the enclosure 4. Both the contactor service area 43 and the fuse service area 45 within the enclosure 4 are generally within the portion of the enclosure 4 beneath the service opening 8 of the top plate 7.

Within the battery pack 1, a first bus bar, positive bus bar 31, and a second bus bar, negative bus bar 33, may span between the service housings 3a-3c, such that the positive bus bar 31 and negative bus bar 33 extend through the passages formed between service housings 3a-3c by abutting left openings 23 and right openings 13. The positive bus bar 31 and negative bus bar 33 may extend through the contactor service area 43 of the adjoining service housings 3a-3c, between the barrier 41 and back side 18, and may be accessible through the service opening 8.

Each contactor service area 43 may further include a first contactor, right string contactor 35, in the corner of the enclosure 4 defined by the right side 12 and the front side 14, and a second contactor, left string contactor 39, in the corner of the enclosure 4 defined by the left side 16 and the front side 14. The right string contactor 35 may be electrically connected to the positive bus bar 31, and the left string contactor 39 may be electrically connected to the negative bus bar 33. Further, the right string contactor 35 may be electrically connected to the positive terminal of a battery cell at an end of the respective right battery cell strings 19 through the right battery ports 25, and the left string contactors 39 may be electrically connected to the negative terminal of a battery cell at an end of the respective left battery cell strings 21 through the left battery port 27.

The fuse service area 45 of each service housing 3a-3c may include electrical connections that connect the negative terminal of the respective right battery cell strings 19 to the right terminal of the disconnect 15 on the side of recess 20 closest to the right side 12 of the enclosure 4, and connect the positive terminal of the respective left battery cell strings 21 to the left terminal of the disconnect 15 on the side of the recess 20 closest to the left side 16 of the enclosure 4. Each fuse service area 45 may further include a fuse 37 between the disconnect 15 and the positive terminal of the left battery cell strings 21. The safety barrier 41 of each service housing 3a-3c may be shaped so as to cover at least a portion of the electrical connections within the fuse service area 45.

Each of the service housings 3a-3c may include electronics to monitor and control the respective battery modules 2a-2c. The service housing 3a may include additional control electronics 49 not found in the other service housings 3b-c, such as a control board, a DC/DC converter, and a pack voltage sensor. The additional control electronics 49 within the service housing 3a may allow the service housing 3a to control the entire battery pack 1. At least some of the additional control electronics 49 may be located on an isolated mount 47 (best seen in service housings 3b-c) extending from the back side 18 of the service housing 3a towards the front side 14. In this position, the control electronics 49 located on the isolated mount 47 may be at least partially within the contactor service area 43 such that they are at least partially accessible through the service opening 8 within the top plate 7 of the service housing 3a.

Each of the service housings 3a-3c may couple to a respective battery module 2a-2c, such that the longitudinal ends of the battery modules 2a-2c abut the exterior of the base 10 of each of the respective service housings 3a-3c. The positive end of the right battery cell strings 19 within each battery module 2a-2c may be electrically connected to the right string contactor 35 within the contactor service area 43 of each respective service housing 3a-3c through the right battery port 25. The negative end of each of the right battery cell strings 19 within each battery module 2a-2c may be electrically connected to the fuse service area 45 and the first, right terminal of the disconnect 15 of each respective service housing 3a-3c through the right battery port 25. The positive end of the left battery cell strings 21 within each battery module 2a-2c may be electrically connected to the fuse service area 45 and the second, left terminal of the disconnect 15 of each respective service housing 3a-3c through the left battery port 27. The negative end of the left battery cell strings 21 within each battery modules 2a-2c may be electrically connected to the left string contactor 39 within the contactor service area 43 each respective service housing 3a-3c through the left battery port 27.

Within each of the service housings 3a-3c, the contactor service area 43 and the fuse service area 45 are electrically connected when the service housing 3a-3c is electrically connected to a battery module 2a-c. More specifically, each of the right battery cell strings 19 and the left battery cell strings 21 provide an electrical connection between a respective contactor service area 43 and fuse service area 45. The right battery cell string 19 and the left battery cell string 21 of each of the battery modules 2a-2c may also be electrically connected in series through their respective electrical connections to the disconnect 15, as described above. Within the battery pack 1, the battery modules 2a-2c are connected in parallel to the positive bus bar 31 and the negative bus bar 33 running through each respective service housing 3a-c.

Due to the series connection of the right battery cell string 19 and the left battery cell string 21 within each service housing 3a-c, dangerously high voltages may occur. In particular, dangerously high voltages may occur within the fuse service areas 45. To decrease the chances of harm to a technician servicing the battery pack 1, the fuse service area 45 is segregated from the contactor service area 43 of each service housing 3a-3c by the safety barrier 41, and the fuse cover 9 is separate from the contactor cover 11. Thus a technician may work on the contactor service 42 area without opening the fuse service area 45, which may aid in preventing accidental contact with the fuse service area 45 while servicing the contactor service area 43.

The following describes the path of the current through a single battery module 2a. It will be understood by those in the art, that as the battery modules 2a-2c are connected in parallel, the following description generally applies to the current flow through any of the battery modules 2a-2c within the battery pack 1. In use, current exits the positive terminal of the right battery cell string 19 and flows through the right string contactor 35 before entering the positive bus bar 31. From the positive bus bar 31, the current may exit the service housing 3a, and flow into external electrical equipment connected to the positive bus bar 31. Upon exiting the electrical equipment, the current may enter the negative bus bar 33 and flow to the left string contactor 39 within the service housing 3a. From there, the current enters the negative terminal of the left battery cell string 21. The current may flow through the left battery cell string 21 until exiting the positive terminal of the left battery cell string 21 and flowing through the fuse 37 to the left terminal of the disconnect 15. When the disconnect 15 is in the closed position, the current may flow from the left terminal of the disconnect 15 to the right terminal of the disconnect 15, before entering the negative terminal of the right battery cell string 19. The current may then flow through the right battery cell string 19 and repeat the circuit.

### INDUSTRIAL APPLICABILITY

The disclosed aspects of the service housings 3a-3c of the battery pack 1 of the present disclosure may be used to monitor and control the output of the battery modules 2a-2c.

The service housings 3a-3c may be combined so as to provide a scalable housing assembly 30 for monitoring and controlling the battery pack 1 as well as the individual battery modules 2a-2c. The design of the service housings 3a-3c allows them to be combinable while preventing dust and water from entering the resulting housing assembly 30. The resulting housing assembly 30 may meet certain criteria for ingress protection (IP) ratings, such as IP 66 and IP 67. Further, the seals within the housing assembly 30 may allow the housing assembly 30 to operate at an altitude of 5,000 m. The design of the service housings 3a-3c also provide added safety protections to technicians servicing the battery pack 1, as the different areas of the service housings 3a-3c are separated from one another.

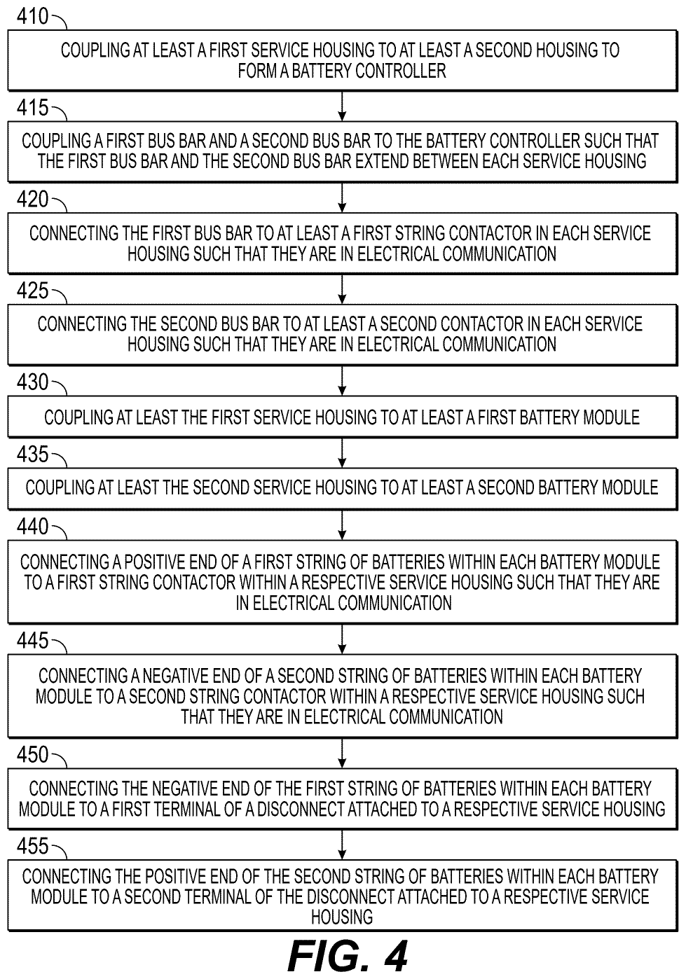

FIG. 4 is a flowchart of an example method for assembling a battery pack 1. At step 410, a first service housing 3a is coupled to at least a second service housing 3b, to form a housing assembly 30. At step 415, the positive bus bar 31 and the negative bus bar 33 are coupled to the housing assembly 30 such that the positive bus bar 31 and the negative bus bar 33 extend between each service housing 3a-3b. At step 420, the positive bus bar 31 is connected to at least the right string contactor 35 in each service housing 3a-3b such that the positive bus bar 31 and the right string contactors 35 are in electrical communication. At step 425, the negative bus bar 33 is connected to at least the left string contactor 39 in each service housing 3a-3c such that the negative bus bar 33 and the left string contactors 39 are in electrical communication. At step 430, service housing 3a of the housing assembly 30 is coupled to at least a first battery module 2a. At step 435, a second service housing, such as service housing 3b of the housing assembly 30, is coupled a second battery module 2b. At step 440, the positive end of the right battery cell string 19 within each battery module 2a-2b is coupled to the right string contactor 35 within a respective service housing 3a-3b such that they are in electrical communication. At step 445, the negative end of the left battery cell string 21 within each battery module 2a-2b is coupled to the left string contactor 39 within a respective service housing 3a-3b such that they are in electrical communication. At step 450, the negative end of the right battery cell string 19 within each battery module 2a-2b is connected to the right terminal of the disconnect 15 attached to a respective service housing 3a-3b. At step 455, the positive end of the left battery cell string 21 within each battery module 2a-2b is connected to the left terminal of the disconnect 15 attached to a respective service housing 3a-3b.

The individual service housings 3a-3c may be individually assembled by first placing a fuse cover 9 over the fuse service area 45 within each service housing 3a-3c. Next, a top plate 7 may be attached to the top end 6 of each enclosure 4. A contactor cover 11 may then be placed within the service opening 8 of each top plate 7 and attached to the support structure 40 of the top plate 7 and/or attachment points within the enclosures 4. A service cover 5 may then attached to the top face of each top plate 7.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A service housing for a battery module, the service housing comprising:
an enclosure coupled to an end of the battery module, and a cover assembly coupled to a service end of the enclosure, the cover assembly including:
a first removable cover removably attachable over a first service area portion of the service end;
a second removable cover removably attachable to the service end and including an opening allowing access to a second service area;
a third removable cover removably positioned within the opening of the second removable cover; and
a fourth removable cover removably attachable to the second removable cover opposite the enclosure so as to cover the opening.

2. The service housing of claim 1, wherein the enclosure comprises a base and a plurality of sides extending generally perpendicularly away from the base towards the service end of the enclosure.

3. The service housing of claim 2, wherein at least one of the sides further includes a first side opening and another, opposite side further includes a second side opening.

4. The service housing of claim 1, wherein the first service area and the second service area are separated by a barrier.

5. The service housing of claim 1, wherein the first service area includes a fuse.

6. The service housing of claim 1, wherein the second service area includes a first contactor and a second contactor.

7. The service housing of claim 1, wherein the second service area includes a first bus bar and a second bus bar.

8. The service housing of claim 1, wherein the first cover and the third cover together overlie the area within the enclosure exposed by the opening within the second cover.

9. The service housing of claim 1, wherein the fourth cover is removably attachable over the first removable cover and the third removable cover; and the first removable cover is beneath the second removable cover, the third removable cover, and the fourth removable cover.

10. A battery pack, the battery pack comprising:
a plurality of battery modules, each module having a service housing connected to a longitudinal end of the battery module, the service housing comprising:
an enclosure coupled to an end of the battery module;
a cover assembly coupled to a service end of the enclosure, the cover assembly including:
a first removable cover removably attachable over a first service area portion of the service end;
a second removable cover removably attachable to the service end and including an opening allowing access to a second service area;
a third removable cover removably positioned within the opening of the second removable cover; and
a fourth removable cover removably attachable to the second removable cover opposite the enclosure so as to cover the opening;
wherein the service housings of each module may be combined so as to form a service housing assembly.

11. The battery pack of claim 10, wherein the enclosure of at least a first service housing includes an opening on at least two sides of the enclosure.

12. The battery pack of claim 11, wherein a doghouse is attached to one of the openings within of the enclosure of the first service housing.

13. The battery pack of claim 12, further comprising at least a second service housing having at least one opening on at least one side of the enclosure, and the second service housing is attached to the first service housing such that the one of the openings of the first service housing and the opening of the second service housing forms a passage between the first service housing and the second service housing.

14. The battery pack of claim 13, wherein a first bus bar and a second bus bar extend through the passage between the first service housing and the second service housing.

15. The battery pack of claim 11, the service housing assembly is dust, air, and water tight when the service housings are combined.

16. The battery pack of claim 11, wherein a first service housing controls the battery pack.

17. The battery pack of claim 11, wherein a first battery module and a second battery module are connected in parallel through the service housing assembly.

18. The battery pack of claim 11, wherein the battery modules each comprise a first string of batteries and a second string of batteries in series.

19. The battery pack of claim 18, wherein a positive end of the first string of batteries in each battery module is electrically connected to the first service area of a respective service housing and a negative end of the first string of batteries in each battery module is electrically connected to the second service area of the respective service housing, and a positive end of the second string of batteries in each battery module is electrically connected to the second service area of the respective service housing and the negative end of the second string of batteries in each battery module is electrically connected to the first service area of the respective service housing.

20. A method of assembling a battery pack, the method comprising:
coupling a plurality of battery modules to form a battery pack,
wherein each battery module includes a service housing comprising an enclosure coupled to an end of the battery module, and a cover assembly coupled to a service end of the enclosure, the cover assembly including:
a first removable cover removably attachable over a first service area portion of the service end;
a second removable cover removably attachable to the service end and including an opening allowing access to a second service area;
a third removable cover removably positioned within the opening of the second removable cover; and
a fourth removable cover removably attachable to the second removable cover opposite the enclosure so as to cover the opening.
